(19) United States
(12) Patent Application Publication
(10) Pub. No.: US 2024/0278729 A1
(43) Pub. Date: Aug. 22, 2024

(54) EXTERNAL VEHICLE STORAGE CONTAINER

(71) Applicant: Justin Rowley, Edmond, OK (US)

(72) Inventor: Justin Rowley, Edmond, OK (US)

(21) Appl. No.: 18/443,819

(22) Filed: Feb. 16, 2024

Related U.S. Application Data
(60) Provisional application No. 63/446,896, filed on Feb. 20, 2023.

(51) Int. Cl. B60R 9/06

(52) U.S. Cl. CPC B60R 9/065

(57) ABSTRACT

A externally mounted storage container for attachment to lug posts or a spare tire apparatus in place of a conventional spare tire on a vehicle may include a container body removably engageable with a spare tire mounting area on a rear gate of the vehicle, the container body including a rear wall and side walls extending outward from the rear wall, the rear wall and the side walls together defining an interior storage space; and at least one door hingeably attached to a forward edge of the side walls, the at least one door configured to open and close with respect to the container body to provide access to and prevent access to the interior storage space. The storage container may also include a mounting bracket attached to an outer surface of the rear wall to facilitate attachment to the vehicle.

### RELATED APPLICATION

This application claims priority to provisional patent application U.S. Ser. No. 63/446,896 filed on Feb. 20, 2023, the entire contents of which is herein incorporated by reference.

### BACKGROUND

The embodiments herein relate generally to vehicle accessories, and more particularly, to an external vehicle storage container specifically designed to attach to the lug posts/spare tire apparatus on the rear/back gate of any vehicle.

Spare tires mounted on the rear/back gate of a vehicle are heavy. In fact, often the vehicles that include these rear mounted spare tires are oversized, and many occupants are unable to actually change a flat without help. As such, including such a spare tire on the rear of the vehicle is often unnecessarily adding weight to the vehicle.

Moreover, drivers are always looking for additional storage in their vehicles. While there are storage containers and devices that attach to the rear-mounted spare tire, there does not currently exist a storage component that attaches to the vehicle in place of the spare tire.

Therefore, what is needed is an external vehicle storage container that attaches to the lug posts/spare tire apparatus in place of a spare tire to provide additional storage.

### SUMMARY

Some embodiments of the present disclosure include an externally mounted storage container for attachment to lug posts or a spare tire apparatus in place of a conventional spare tire on a vehicle. The storage container may include a container body removably engageable with a spare tire mounting area on a rear gate of the vehicle, the container body including a rear wall and side walls extending outward from the rear wall, the rear wall and the side walls together defining an interior storage space; and at least one door hingeably attached to a forward edge of the side walls, the at least one door configured to open and close with respect to the container body to provide access to and prevent access to the interior storage space. The storage container may also include a mounting bracket attached to an outer surface of the rear wall to facilitate attachment to the vehicle.

### BRIEF DESCRIPTION OF THE FIGURES

The detailed description of some embodiments of the invention is made below with reference to the accompanying figures, wherein like numerals represent corresponding parts of the figures.

FIG. 1 is a perspective view of one embodiment of the present disclosure, mounted on the rear of a vehicle 11.

FIG. 2 is a front perspective view of one embodiment of the present disclosure.

FIG. 3 is a rear perspective view of one embodiment of the present disclosure.

FIG. 4 is a partially exploded perspective view of one embodiment of the present disclosure, showing doors 14 open.

FIG. 5 is a partially exploded perspective view of one embodiment of the present disclosure.

FIG. 6 is a clam-shell style, exploded perspective view of one embodiment of the present disclosure.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as an external storage container for a vehicle and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The elements of the device of the present disclosure may be related in the following exemplary fashion. It is not intended to limit the scope or nature of the relationships between the various elements and the following examples are presented as illustrative examples only.

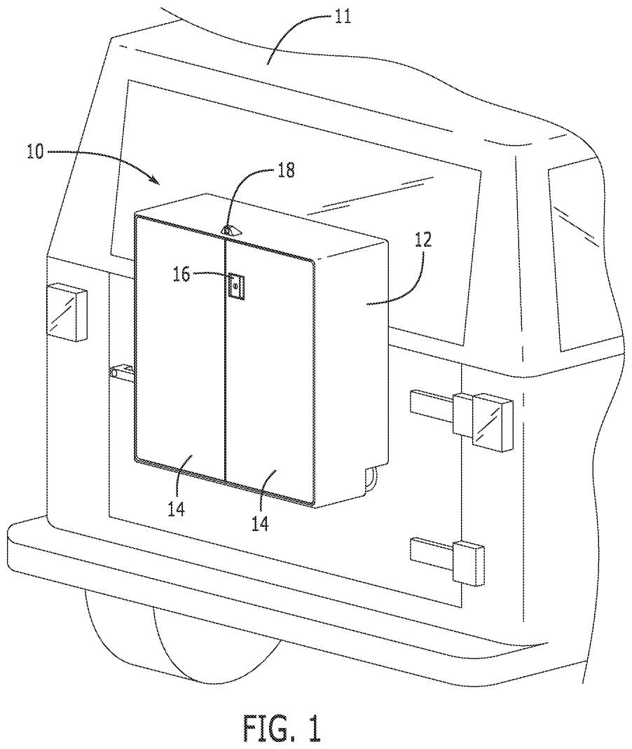

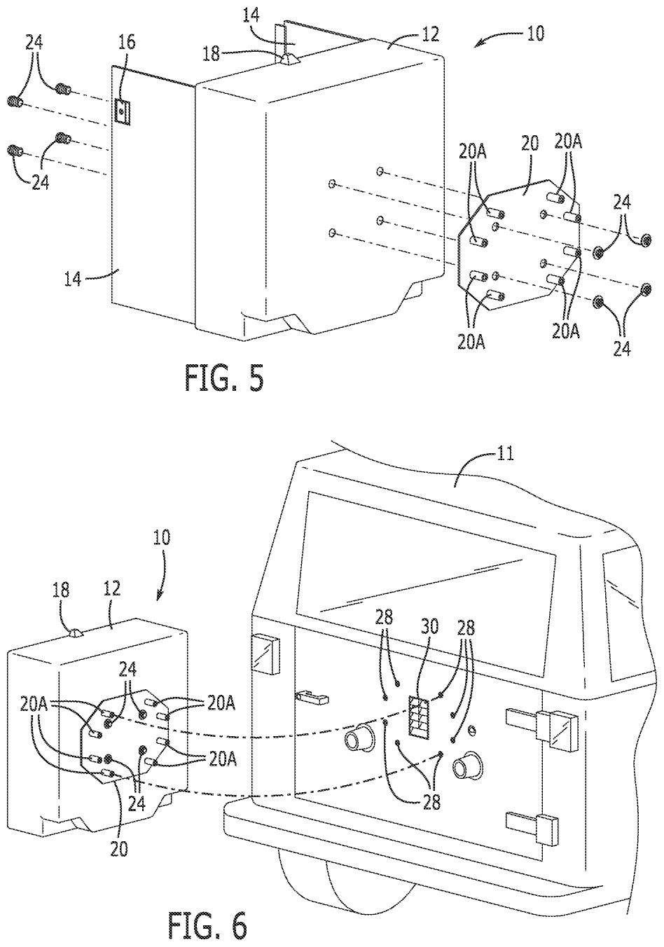

By way of example, and referring to FIGS. 1-6, some embodiments of the present disclosure include an externally mounted storage container 10 configured to attach to lug posts or a spare tire apparatus in place of a conventional spare tire on a vehicle 11, the externally mounted storage container 10 comprising a container body 12 configured to removably engage with a spare tire mounting area on a rear gate of the vehicle 11, the container body comprising a rear wall and side walls extending outward from the rear wall, the rear wall and the side walls together defining an interior storage space 22; and at least one door 14 hingeably attached to the forward edge of the side walls, the at least one door 14 configured to open and close with respect to the container body 12 to provide access to and prevent access to the interior storage space 22, as desired.

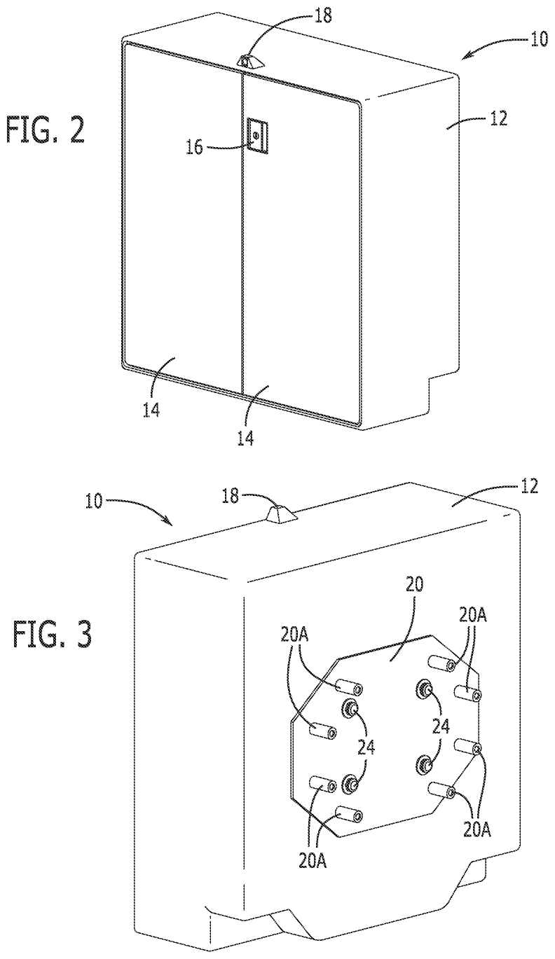

In some embodiments, and as shown in the Figures, the eternally mounted storage container 10 may further comprise a mounting bracket 20 removably engaged with an outer surface of the rear wall of the container body 12, wherein the mounting bracket 20 is configured to also removably engage with lug post holes 28 on the rear gate of the vehicle 11. More specifically, and as shown in FIG. 2, the mounting bracket 20 may comprise a plate with a plurality of lug posts 20A extending therefrom, wherein the lug posts 20A are positioned to as to align with the lug post holes 28 on the vehicle 11. Because different vehicles have different arrangements of lug post holes 28, it is envisioned that the positioning of the lug posts 20A extending outward from the mounting bracket plate may vary, as needed. Thus, depending on which vehicle a user wishes to mount the externally mounted storage container 10 to, a different mounting bracket 20 may be attached to the outer surface of the rear wall of the container body 12. The mounting bracket 20 may be attached to the container body 12 using any conventional attachment mechanisms. For example, and as shown in the Figures, each of the mounting bracket and the rear wall of the container body 12 may comprise a plurality of fastener holes extending therethrough, wherein a conventional fastener 24, such as a bolt, may be used to attach the mounting bracket 20 to the container body 12 by securing the fasteners 24 within the fastener holes.

In other embodiments, the mounting bracket 20 may be permanently attached to or integrated into the structure of the rear wall of the container body 12. However, in these instances, a user may not be able to interchange the mounting bracket 20 and, thus, the externally mounted storage container 10 may only be used with specific vehicles with the specific lug hole 28 arrangements. In yet further embodiments, the container body 12 may simply have a plurality of lug post holes extending through the back wall thereof, wherein the container body 12 may be secured to the existing lug posts on the vehicle 11 by inserting the lug posts through the lug post holes and securing with a conventional fastener or bolt.

As mentioned above, the container 10 may comprise at least one door 14 hingeably attached to a distal or front edge of the side walls of the container body 12. More specifically, and as shown in the Figures, the container 10 may comprise a pair of doors 14, each door being hingeably attached to an opposite side wall, wherein when closed, the doors 14 meet at a central location of the container 10. For example, the container 10 may comprise a right door attached to a right edge of the container body 12 and a left door attached to the left edge of the container body. Regardless of the number or orientation of the door(s) 14, the container 10 may also comprise a lock or latch 16 configured to lock the door(s) 14 in a closed position, thus preventing or reducing the likelihood of theft of objects stored within the container 10. As shown in the Figures, the container 10 may also have a backup camera 18 mounted thereto, wherein the backup camera 18 may be operatively attached to a monitor, such as the entertainment system screen or an aftermarket screen, within the interior of the vehicle 11.

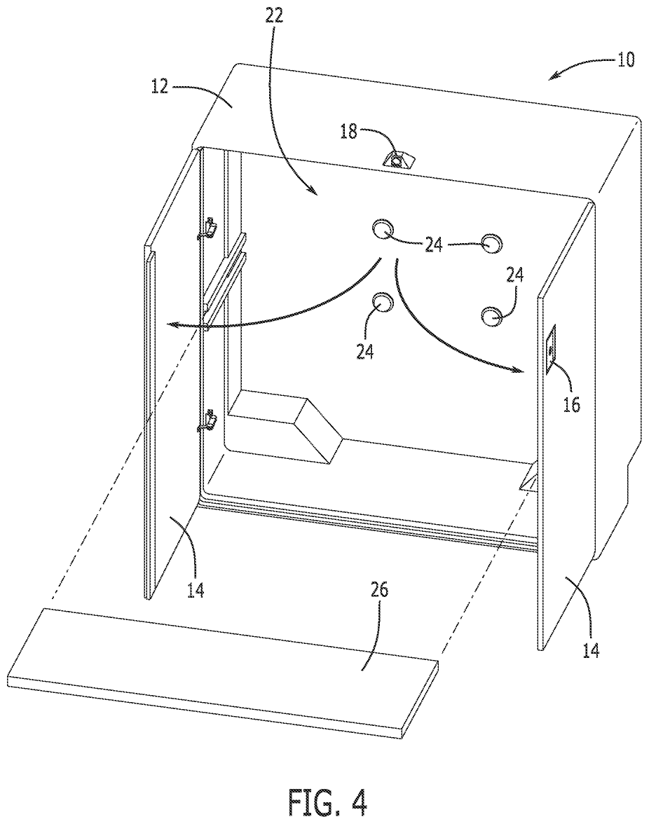

As shown in FIG. 4, the container 10 may further comprise a partition 26 positioned within the interior storage space 22. As shown, the partition 26 may comprise a shelf that is slidably mounted to shelf brackets attached to the interior surface of the sidewalls of the container body 12. The partition 26 may function as a shelf for storing items and also as a support to prevent the door(s) 14 from being pushed into the interior storage space 22 of the container body 12. In some embodiments, the partition 26 may be removed to allow for the storage of larger items. However, in alternatively embodiments, the partition 26 may be permanently mounted within the interior storage space 22.

While not shown in the Figures, the container 10 of the present disclosure may include other various optional components, such as a brake light ring, attached to an appropriate surface thereof.

While the storage container 10 of the present disclosure is depicted in the drawings as being substantially square shaped, the container 10 is not limited to any particular shape or size, so long as the container body 12 is configured to removably engage with the rear gate or rear surface of the vehicle 12 in place of a spare tire. Also, while the container 10 is shown with a left door 14 and a right door 14 that meet in the middle, the container 10 is not limited to such configuration, and the use of any variation of door or doors is envisioned. The storage container 10 of the present disclosure may be made of any suitable materials and, in some embodiments, may comprise a lightweight, hard material, such as plastic or metal, wherein the material is configured to withstand environmental factors, such as snow, rain, wind, sun, and the like.

To use the device of the present disclosure, a person would remove the spare tire from the rear gate or rear end of their vehicle 11. The container body 12 (with or without the mounting bracket 20, depending on the version of the container 10) may be positioned to engage with the lug holes 28 on the vehicle 11, which may result in the container body 12 being positioned over an air vent on the vehicle 11. The container body 12 may be secured in place using fasteners. Once the container body 12 is secure, the door(s) 14 may be open, closed, locked, or unlocked, and items may be stored therein. Thus, the storage compartment 10 of the present disclosure may function as an alternative to a vehicle spare tire and may offer a lightweight option to increase vehicle fuel efficiency by lowering overall weight while simultaneously increasing vehicle storage space.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An externally mounted storage container configured to attach to lug posts or a spare tire apparatus in place of a conventional spare tire on a vehicle, the externally mounted storage container comprising:
a container body configured to removably engage with a spare tire mounting area on a rear gate of the vehicle, the container body comprising a rear wall and side walls extending outward from the rear wall, the rear wall and the side walls together defining an interior storage space; and
at least one door hingeably attached to a forward edge of the side walls, the at least one door configured to open and close with respect to the container body to provide access to and prevent access to the interior storage space.

2. The externally mounted storage container of claim 1, wherein the rear wall of the container body comprises a plurality of fastener orifices extending therethrough.

3. The externally mounted storage container of claim 2, wherein the plurality of fastener orifices are positioned to align with and engage with lug posts extending from the vehicle.

4. The externally mounted storage container of claim 2, further comprising a mounting bracket, wherein:
the mounting bracket is mounted to the container body with fasteners engaged with the plurality of fastener orifices; and
the mounting bracket comprises a plate with a plurality of lug posts extending outward therefrom, the plurality of lug posts configured to engage with lug orifices on the vehicle.

5. The externally mounted storage container of claim 1, further comprising a partition mounted within the interior storage space.

6. The externally mounted storage container of claim 1, further comprising a lock operatively attached to the at least one door.
